(19) United States
(12) Patent Application Publication
(10) Pub. No.: US 2016/0311089 A1
(43) Pub. Date: Oct. 27, 2016

(54) Hydraulic Torque Wrench with Stacked Drive Plate Cartridge, Multiple Cartridge Pawls and Snap-in Retract Lock

(71) Applicants: John D. Davis, Las Vegas, NV (US); Johannes P. Schneeberger, Brisbane, CA (US)

(72) Inventors: John D. Davis, Las Vegas, NV (US); Johannes P. Schneeberger, Brisbane, CA (US)

(21) Appl. No.: 14/693,650

(22) Filed: Apr. 22, 2015

(51) Int. Cl. B25B 21/00; B25B 23/00

(52) U.S. Cl. CPC B25B 21/005; B25B 23/0007

(57) ABSTRACT

Drive plates of a hydraulic torque wrench are stacked and mating combined in a cartridge for extended surface contact within the ratchet teeth width of the joints along the piston force transmission path into the drive plates and into the cartridge pawls. A snap-in retract lock provides for an easy connect with the cartridge also in case of a rotationally coupled modular torque wrench. There, the stacked and mated drive plates are rotationally guided in the housing leaving the ratchet wheel peripherally clear for maximum housing support. The pawls interface the ratchet teeth with contact pressures that increase at the ratchet teeth grooves and gradually propagate away from the ratchet wheel axis such that the ratchet teeth edges remain free of peak pressures and deformations.

### CONTINUATION IN PART

The present Application is a Continuation in Part to the US Patent Application of the John D. Davis titled “Compact Hydraulic Torque Wrench Cartridge” Attorney Docket No.: HTR1011US, application Ser. No. 14/258,344.

### FIELD OF INVENTION

The present invention relates to hydraulic torque wrenches utilizing a ratchet wheel.

### BACKGROUND OF INVENTION

Hydraulic torque wrenches are well known power tools for tightening and loosening nuts and bolts. A hydraulic pump commonly pressurizes a hydraulic fluid that is circulated to and from the hydraulic torque wrench via hoses. The hydraulic torque wrench itself commonly features a piston that transforms the fluid pressure into a piston force, which in turn is transferred via a piston rod onto drive plates, and via one or two pawls onto a ratchet wheel that is sandwiched between the drive plates. The ratchet wheel commonly connects to a nut or itself has an internal cutout that matches the nut or bolt head to be tightened or loosened.

Since nuts and bolts are commonly tightly assembled, it is desirable to have a hydraulic torque wrench as compact as possible while at the same time providing a maximum torque and reliable and lasting functionality. The weakest link in the force transmission path from the hydraulic piston to the ratchet wheel is/are commonly the pawl(s) that has/have to reliably engage with a corresponding tooth of the ratchet wheel. Ratchet wheel and pawl(s) are assembled in a cartridge between two lateral plates as is well known in the art. During return travel of the hydraulic piston, the pawl(s) has/have to disengage with the ratchet wheel. Since the pawl(s) is/are much closer positioned to the torque transfer axis than the commonly more peripheral piston rod—drive plate interface, the actual force transmitted across the pawl(s) is in accordance with the well known lever principle substantially higher than the actually produced piston force. Excessive wear commonly occurs in the plate-pawl and pawl-tooth interfaces. Therefore, there exists a need for improved plate-pawl and pawl-tooth interfaces. The present invention addresses this need.

Due to the tight space a maximum of two drive pawls have been employed in the prior art to divide the force to be transmitted onto the ratchet wheel. Nevertheless, even with two drive pawls the peak pressures are still excessive. Therefore, there exists a need for a three drive pawls. The present invention addresses this need.

Ratchet cartridges need to be conveniently connected and disconnect especially in cases of modular torque wrenches with a separate power head housing the hydraulic piston and a link housing the ratchet mechanism. Therefore, there exists a need for a simple and reliable connection between ratchet cartridge and piston rod that can be fast and easily disconnected and reconnected. The present invention addresses also this need.

For limited clearance applications, at least a portion of the outer diameter around the torque transfer axis of the torque wrench needs to be kept to a minimum while at the same time keeping the overall width of the wrench along the torque transfer axis also needs to be kept to the minimum. In the prior art, the limited available space had to be divided up for the ratchet teeth section of the ratchet wheel, the drive plates wrapping around the ratchet wheel and the housing that is holding the ratchet wheel. Therefore there exists a need for a configuration where the limited available space is needs to be divided up mainly only between components of the ratchet wheel and the housing. The present invention addresses this need.

### SUMMARY

A ratchet cartridge features preferably two drive plates that extend within the width of the ratchet wheel teeth. The drive plates are held together and are additionally stiffened by dowel pins and shoulder screws. The contacting drive plates provide for plate-pawl interfaces that extend across the entire width of the cartridge pawls, which substantially reduces contact pressures and affiliated wear in the plate-pawl interfaces.

The member-plate interface between a piston force transfer member and the drive plates includes a push face at the distal end of the piston rod pushing either directly or via a slide able push stone onto a rod receive face within the drive plates. The region around the member-plate interface axis is thereby freed from direct piston push force transfer. Instead, axially slide able and spring loaded snap pins are employed that engage either with corresponding pin receive holes or a retract cam of the drive plates. Via a release access, the retract lock and ratchet cartridge may be conveniently disengaged. To reassembly the ratchet cartridge, the snap-in retract lock is automatically depressed by pin actuation chamfers while the ratchet cartridge and piston rod end are moved together. The retract lock snaps in as soon as the member-plate interface comes into mating contact.

Preferably three cartridge pawls are employed and the load transfer between them is balanced out by adjusting the pitch of their plate-pawl interfaces around the torque transfer axis in correspondence with the load deformation of the drive plates, ratchet wheel and cartridge pawls.

A reliable and balanced contact pressure distribution in the pawl-tooth interfaces is achieved by defining on one hand a contact angle between the cartridge pawl front faces and the ratchet tooth flanks of the pawl-tooth interfaces such that a gap between the cartridge pawl end face and the ratchet tooth flank increases in direction away from the torque transfer axis while the cartridge pawl end faces are in a load free contact with their mating ratchet tooth flanks. On the other hand, at least one of the cartridge pawl front face and the ratchet tooth flanks have a curvature such that a contact pressure in the pawl-tooth interface increases in the ratchet teeth grooves and propagates gradually in direction away from the torque transfer axis during a load increase and a corresponding elastic deformation in said pawl-tooth interface. At the same time a resulting torque on the pawls causes them to be pushed into the ratchet teeth grooves, which effectively prevents inadvertent snapping free of the cartridge pawls under load.

### BRIEF DESCRIPTION OF THE FIGURES

FIG. 1 is a first spatially angled view onto a hydraulic torque wrench according to first embodiment of the invention.

FIG. 2 is the first spatially angled view of the ratchet cartridge and a hydraulic piston assembly of FIG. 1.

FIG. 3 depicts the content of FIG. 2 without one frontal drive plate.

FIG. 3A is detailed cut view of an alternate piston rod configuration with release access to the snap-in retract lock.

FIG. 4 is a second spatially angled view onto the drive plate and the cut piston and a portion of the piston rod.

FIG. 5 is a side view of the piston rod and the cut piston, and ratchet cartridge.

FIG. 5A is a detail view of FIG. 5.

FIG. 6 is the second spatial angled view of a first piston rod portion and the cut piston, second piston rod portion and ratchet cartridge.

FIG. 7A is a third spatial angled cut view of a second embodiment of the invention.

FIG. 7B shows the same as FIG. 7A without link housing and push stone.

FIG. 8 is a fourth spatial angled back cut view of the second embodiment of the invention without power head housing and rod support.

FIG. 8A is a detailed view as indicated in FIG. 8 by the numeral 8A. Piston rod and rod support are not shown.

### DETAILED DESCRIPTION

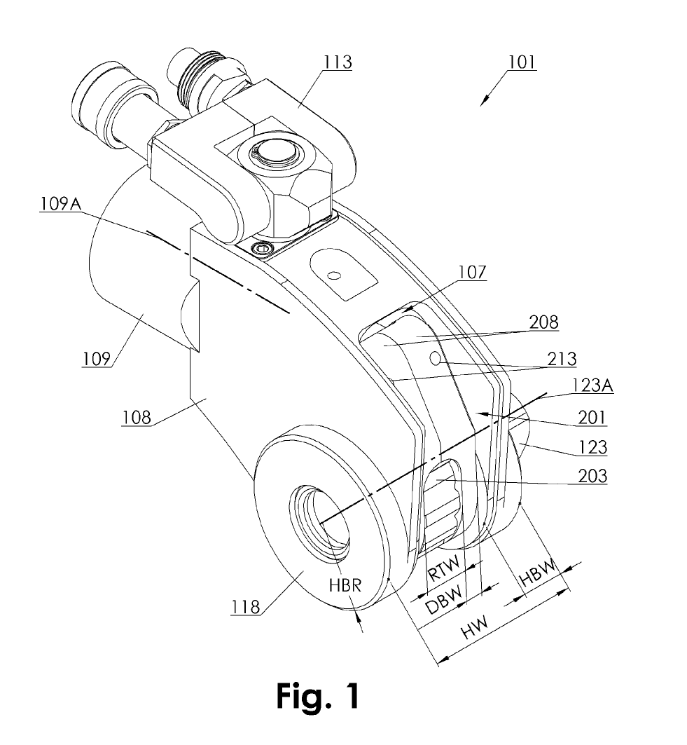

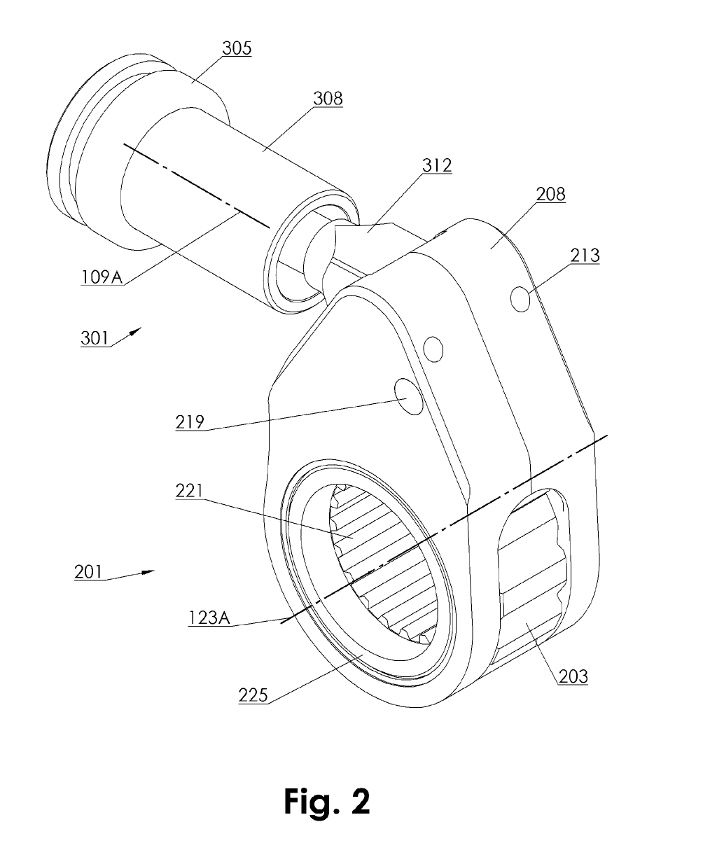

Referring to FIGS. 1-6, a hydraulic torque wrench 101 has a hydraulic piston 305 that is transforming a hydraulic pressure into a piston force along a piston axis 109A. The pressurized fluid is preferably communicated to and from hydraulic torque wrench 101 via a hose connect swivel 113 peripherally connected to a housing 105. The housing 105 has a cartridge housing 108 with a cartridge cavity 107 that encapsulates a ratchet cartridge 201 and a piston housing 109 that encapsulates a piston assembly 301 including the hydraulic piston 305 and a piston sleeve 308. An attachment flange 118 is preferably around a torque transfer axis 123A at a distal end of the cartridge housing 108. A torque transfer feature 123 is rotate able around the torque transfer axis 123A and may be an external feature extending outside the cartridge housing 108 such as a square stud as shown in the FIG. 1. The torque transfer feature 123 may also be an internal feature residing inside the cartridge housing 108 as is well known in the art.

A piston rod 312 is in contact with the hydraulic piston 305 and is receiving the piston force from the hydraulic piston 305. The piston rod 312 has a rod rear 313 that is mating the hydraulic piston at its end and a rod head 314 that has at its end a rod push face 322 and a rod retention hole 316. The rod push face 322 is corresponding to a rod receive face 228 of drive plates 208 that sandwich and partially encompass a ratchet wheel 203. Drive plates 208 and ratchet wheel 203 are part of the ratchet cartridge 201. The rod retention hole 316 is corresponding to snap pin receive holes 216 preferably in both drive plates 208. The rod push face 322, rod receive face 228, rod retention holes 316 and snap pin receive holes 216 are part of a member-plate interface 215 and are preferably concentric with respect to member-plate interface axis 208A. The drive plates 208 receive the piston force from the piston rod 312 via the member-plate interface 215.

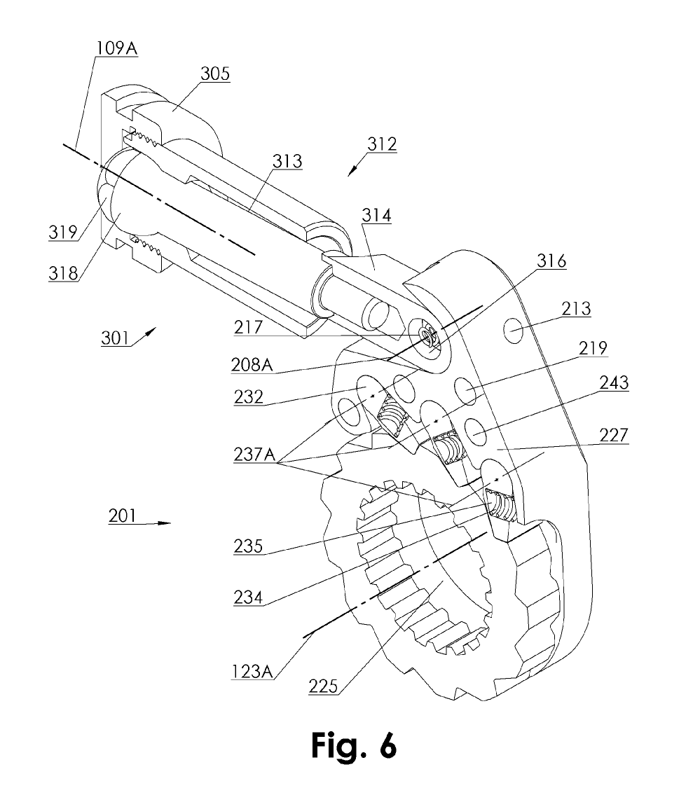

Due to the snap-in retract lock between the piston rod 312 and ratchet cartridge 201, the rod rear 313 and rod head 314 may be pre assembled through the piston sleeve 308 prior to attachment of the piston sleeve 308 with hydraulic piston 305. In FIG. 6 the rod rear 313 is shown in uncut view with its spherical rod rear head 318 and a tightening crown 319 with preferred contour of a hex that is radially recessed into the spherical rear head 318. Via the tightening crown 319, the rod rear 313 may be conveniently screwed into and combined with the rod head 314 through the piston sleeve 308. This provides for a rod combine interface between the rod rear 313 and the rod head 314 that does not need to be structurally compromised to accommodate for radial tightening flats as they are well known in the prior art. As a favorable result, the rod combine interface has improved structural strength to transfer the piston force while reducing the risk of buckling. The tightening crown 319 in turn fits in between the piston/rod interface and the rod/sleeve interface without compromising their contact areas.

Part of the ratchet cartridge 201 are also preferably three cartridge pawls 232 that receive the piston force from the drive plates 208 via respective plate-pawl interfaces 233. The cartridge pawls 232 preferably each feature a cartridge pawl wing 238 and a cartridge pawl shaft 236 that sticks out on both ends. The cartridge pawl wing 238 has a spring blind hole 235. On its distal end it has a cartridge pawl front face 240 and a pawl front edge radius 239. Cartridge pawl springs 234 may be contained in the spring blind holes 235 and push the cartridge pawl wings 238 towards the ratchet wheel 203. Part of each plate-pawl interface 233 is a pawl shaft mating face 237 provided by the drive plates 208 and the cartridge pawl shaft 236 that are concentric to each other and their respective interface axes 237A.

The ratchet wheel 203 is rotate able held in the cartridge housing 108 and rotate able held on to by the drive plates 208 concentric with respect to the torque transfer axis 123A. The ratchet wheel 203 is receiving the piston force from the cartridge pawls 232 via a pawl-tooth interface such that the piston force is transformed into a torque around the torque transfer axis 123A. Part of each pawl-tooth interface is a respective pawl front face 240 and pawl front edge radius 239 on the side of the cartridge pawls 232 and a respective one of a number of ratchet tooth flanks 205 and tooth base radii 207 on the side of the ratchet wheel 203. Ratchet tooth flanks 205 and tooth base radii 207 are arrayed around the circumference of the ratchet wheel 203 in a ratchet teeth pitch 205P. Respective pawl front edge radii 239 and tooth base radii 207 are defining pawl-tooth interface axes 207A through which a cartridge force vector 232V passes at the moment the piston force starts to ramp up.

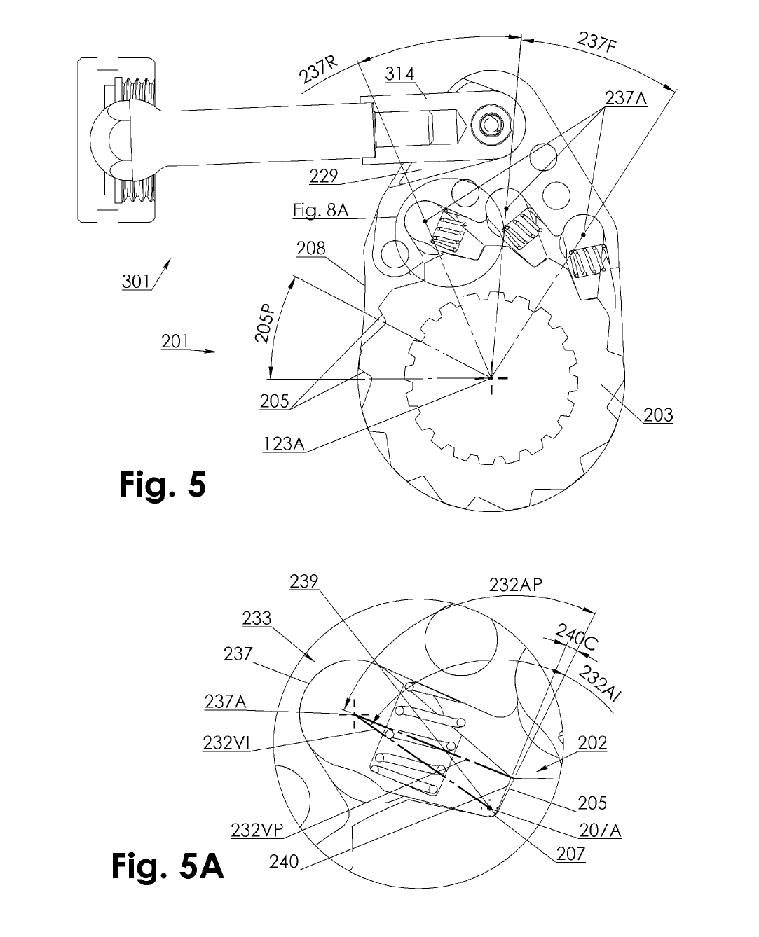

During initial piston force transfer and before elastic deformation occurs in the drive plates 208, the ratchet wheel 203 and the cartridge pawls 232, contact in the pawl-tooth interfaces is substantially only between the respective tooth base radii 207 and pawl front edge radii 239. Consequently and as is clear to anyone skilled in the art, each respective initial force vector 232V1 is angularly defined by the position of the respective plate-pawl interface axis 237A and pawl-tooth interface axis 207A within the ratchet cartridge 201 as shown in FIG. 5A. At the same time and while the plate-pawl interfaces 233 are in a substantially load free mating contact, the cartridge pawl front faces 240 and respective ratchet tooth flanks 205 are in a pawl clearance angle 240C such that a gap between them increases in direction away from the torque transfer axis 123A. The initial force vector 232V1 is in an initial vector angle 232A1 to the respective tooth flank 205 within the ratchet cartridge 201 and within a mating pawl-tooth interface that is substantially less than ninety degrees.

In addition, at least one of the cartridge pawl front face 240 and the ratchet tooth flank 205 may feature a curvature such that a contact pressure in the pawl-tooth interface 202 propagates in direction away from the torque transfer axis 123A during a load increase and a corresponding elastic deformation in the pawl-tooth interface 202. As the piston force starts, initial piston force transfer in the pawl-tooth interface 202 is across the pawl front edge radii 207 and respective tooth base radii 207 only. Due to the off perpendicular initial vector angle 232A1, a resulting initial torque forces the respective cartridge pawl 232 towards the ratchet wheel 203 as is clear to anyone skilled in the art. As the piston force ramps up, deformations occur in drive plates 208, ratchet wheel 203 and cartridge pawls 232 that cause the clearance angle 240C to decrease and contact pressure to extend more and more into the ratchet tooth flanks 205 and pawl front faces 240. The clearance angle 240C and eventual contact face curvatures are selected in conjunction with the deformation behavior of drive plates 208, ratchet wheel 203 and cartridge pawls 232 and a predetermined maximum of the piston force such that only at the predetermined maximum piston force, contact pressures in the pawl-tooth interfaces reach the circumferential end of the ratchet teeth 205. In that way, the risk of snapping free of the cartridge pawls 232 under peak load due to wear in the pawl-tooth interface is substantially eliminated. In addition, the position of the plate-pawl interface axes 237A within the ratchet cartridge assembly 201 and the tooth angle 205A of the ratchet tooth flanks 205 with respect to the torque transfer axis 123A are selected such that the peak vector angle 232AP remains below ninety degrees. As a result, even during peak piston force transfer, there remains a torque that forces the cartridge pawls 232 towards the ratchet wheel 203. This also effectively opposes inadvertent snapping free of the cartridge pawls 232 during peak piston force transfer. The clearance angle 240C is preferable between 0.5 and 5 degrees.

Preferably both drive plates 208 feature a drive plate base 209 that extends lateral to the ratchet wheel 203 and a drive plate castle 210 that extends within the width of the ratchet wheel 203. The drive plate castles 210 of both drive plates 208 are preferably in direct contact along respective plate mating faces 227 while each of the two drive plates 208 is assembled on one of the two lateral sides of the ratchet wheel 203. The drive plates 208 are connected with dowel pins 243 and a drive plate tensioner 219 such as a well known shoulder screw. The dowel pins 243 and drive plate tensioner 219 extend radially tight within dowel pin holes 244 and tensioner hole 220 through the drive plate castes 210 up to the plate mating faces 227. The radial tight fit up to the plate mating faces 227 provides accurate positioning of the two drive plates 208 with respect to each other within the ratchet cartridge 201 and increases bending stiffness of the two drive plates 208 as is clear to anyone skilled in the art. The stiffened drive plate castles 210 provide for balanced contact pressures in the rod-plate and plate-pawl interfaces that preferably extend within the drive plate castles 210.

The member-plate interface with its rod push face 322 and a rod receive face 228 is snug contacting the rod push face 322 while the member-plate interface is in mating contact. As a favorable result, the piston force is directly transferred from the piston rod 312 onto the drive plates 208 across a substantially larger interface area than in prior art pin style rod-plate push force transferring interfaces. This reduces contact pressures and reduces wear. At the same time it gives room for the snap-in retract lock in the central area around the member-plate interface axis 208A around which the piston rod 312 is rotate able with respect to the drive plates 208 while the member-plate interface 215 is in mating contact.

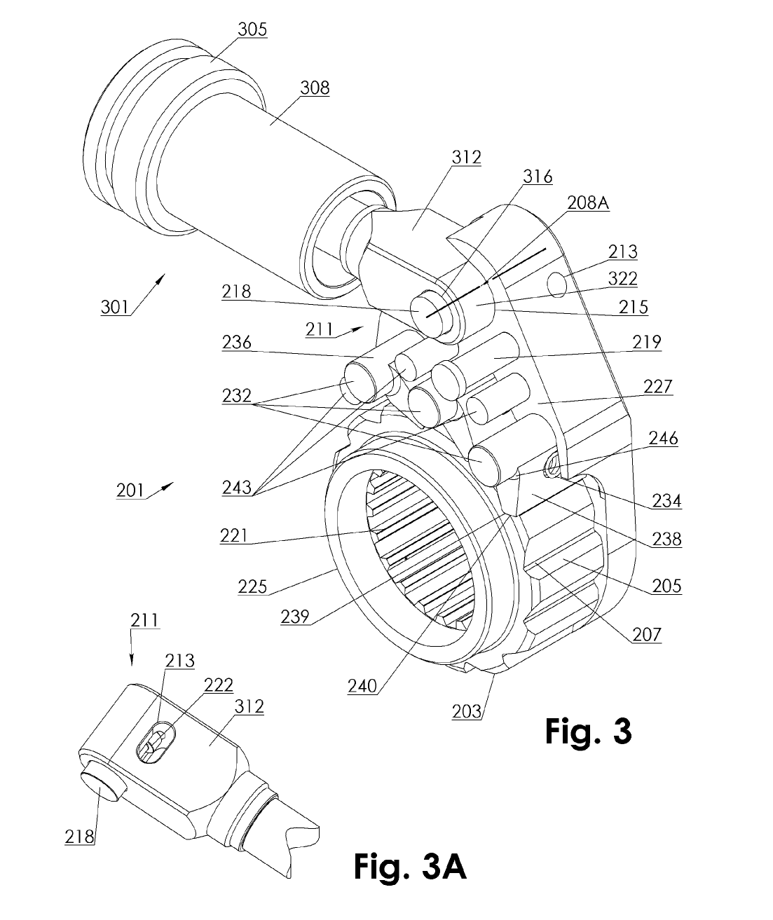

As in FIG. 3, the snap-in retract lock 211 of the first embodiment 101 may include two rod snap pins 218 that are axially with respect to the member-plate interface axis 208A slide able and spring loaded via a snap pin spring 217 within the rod retention hole 316. While the member-plate interface is in mating contact, the rod retention hole 316 is axially aligned with the snap pin receive holes 216 to axially receive the rod snap pins 218 and lock the member-plate interface rotate able. The member-plate interface axis 208A is perpendicular to the piston axis 109A. Release accesses 213 provide peripheral access across the drive plates 208 to the snap pin receive holes 216. As a result, the snapped in pins 218 may be conveniently peripherally disengaged from the snap pin receive holes 216 via the release accesses 213. The release accesses 213 are preferably blind holes extending approximately perpendicular to the snap pin receive hole 216 across the drive plates 208 for accessing the rod snap pins 218 across the drive plates 208 in a direction substantially aligned with the piston axis 109A. That way, the ratchet cartridge 201 is accessed for disengaging from the piston rod 312 by removing only a well known housing shroud from the cartridge housing 108 as is depicted in FIG. 1. This greatly simplifies replacement of the ratchet cartridge 201 compared to the prior art. To reconnect the ratchet cartridge 201 with the piston rod 312 within the otherwise assembled hydraulic torque wrench 101, the ratchet cartridge 201 merely needs to be pushed with its rod clearance cutout 229 towards the rod head 314. As the clearance cutout 229 slips over the rod head 314, the laterally extending rod snap pins 218 are depressed against the snap pin spring 217 by the pin actuation chamfers 214 along the peripheral edges of the rod clearance cutout 229.

As in FIG. 3A, the snap-in retract lock 211 may have its release access 213 provided by the piston rod. A single snap pin 218 may be spring loaded held in the piston rod. The snap pin 218 a snap pin access shoulder 222 via which the snap pin 218 may peripherally accessed for disengaging of it.

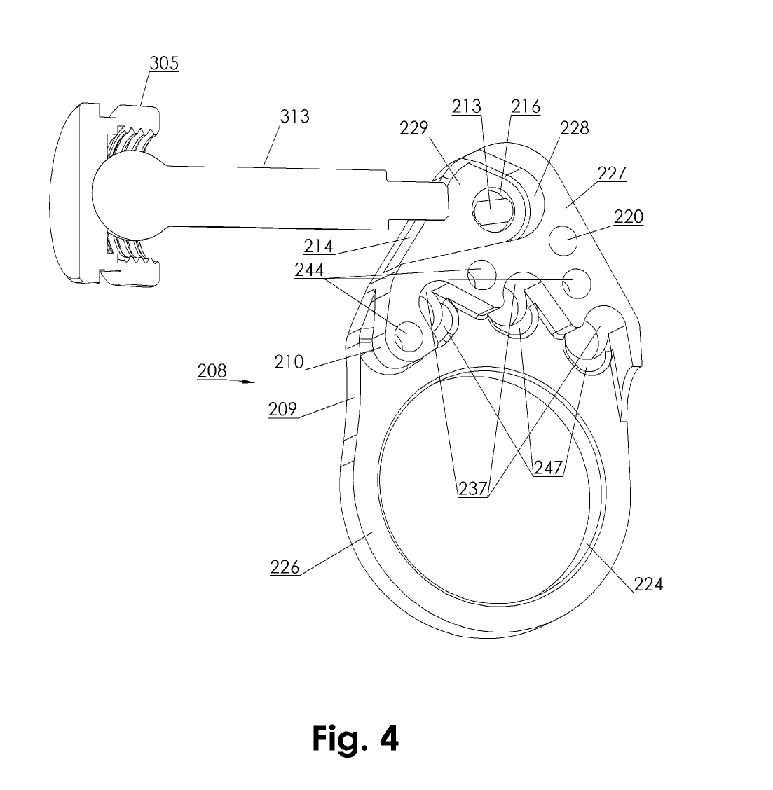

The piston forces may cause bending stresses in the studs of the pawl shafts 236 and substantial stress concentrations in the transition corners between the cartridge pawl wings 238 and the shaft studs extending beyond the cartridge pawl wings 238. A pawl shaft transition radius 246 placed there substantially evens out such stress concentrations. To provide room for these pawl shaft transition radii 246, pawl shaft corner clearances 247 may be recessed into the drive plate bases 209 as shown in FIG. 4.

The drive plates 208 are rotate able holding on to ratchet wheel flanges 225 on both lateral ends of the ratchet wheel 203 via ratchet wheel bushings and ratchet side mating faces 226 as is well known in the art. The ratchet wheel 203 has an internal torque transfer spline 221. In the depicted embodiment with an external torque transfer feature 123 such as a well known square end shaft, the torque transfer spline 221 is engaging with a mating spline of the shaft, which in turn is rotate able held in the cartridge housing 105 as is well known in the art. In an alternate configuration of the claimed hydraulic torque wrench 101 and ratchet cartridge 201 for limited clearance applications, the torque transfer spline 221 may be configured and shaped to mate directly with a nut and/or bolt to be tightened and/or loosened. In that case, the lateral ratchet wheel flanges 225 may axially extend beyond the drive plates 208 for a direct rotate able hold within the attachment flanges 118.

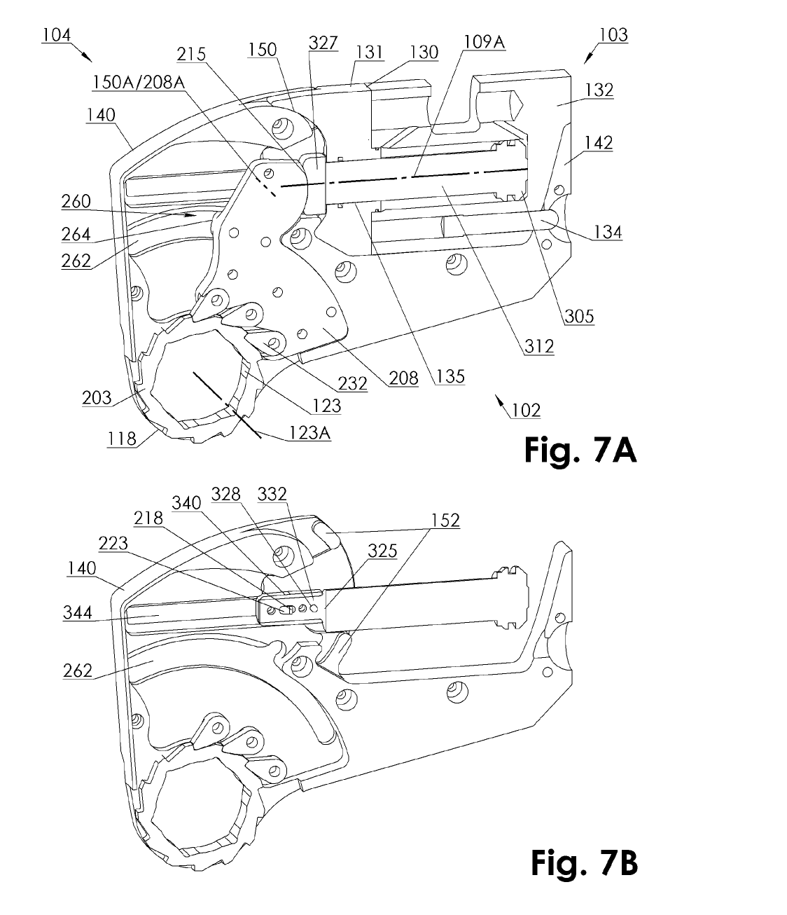

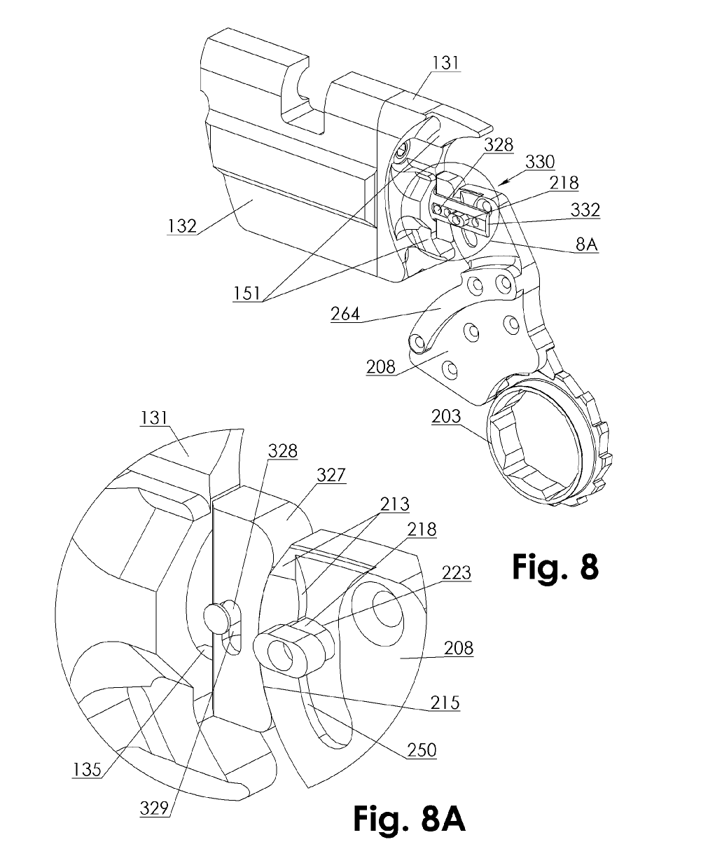

Referring to FIGS. 7-8A, a second embodiment of a torque wrench 102 is described for limited clearance applications where the mating shape of the bolt head and/or nut to be tightened or loosened is formed inside the ratchet wheel 203 as is well known in the art. In the FIGS. 7-8A, the assemblies are depicted cut along a central symmetry plane that is perpendicular to the torque transfer axis 123A. Well known screws, pins, springs, seals and hose connect swivel are omitted for clarity.

The torque wrench 102 may have a housing split into power head housing 130, a link housing 140 and a pivot coupling 150 that is coupling both of them. The power head housing 130 is housing at least the hydraulic piston 305 and piston rod 312. The link housing 140 is housing at least the drive plates 208, the cartridge pawls 232 and the ratchet wheel 203. The pivot coupling 150 has a coupling axis 150A around which the link and power head housings 140, 130 may be rotationally coupled and locked together as should be clear to anyone skilled in the art. The coupling axis 150A may be coincident with respect to the member-plate interface 215 while the drive plates 208 are in full retract position as shown in the FIGS. 7-8A. To arrest the link and power head housings 140, 130 in coupled position, the power head housing 130 may feature a spring loaded peripheral housing snap pin 132 and the link housing 140 a peripheral coupling hook 142. The peripheral housing snap pin 132 snaps in the peripheral coupling hook 142 while the link housing 140 is rotationally fully coupled with the power head housing 130.

In the torque wrench 102, the hydraulic piston 305 and piston rod 312 are at least rigidly combined but preferably monolithic. To assembly it, the power head housing 130 is preferably split into a power head bracket 131 and a power head body 132 that are screwed together. The power head bracket 131 provides the power head coupling features 151 and the piston rod shaft 135 that linearly guides the piston rod 312 with the piston 305. The power head body 132 provides the well known hydraulic cylinder, oil channels and features for a well known hose connect swivel. The piston rod 312 has on its end that is extending out of the bracket 131 at least one but preferably two rod extension wings 332 and a rod push face 325. The force transfer member is a push stone 327 in slide able snug contact with the rod push face 325. The push stone 327 slides adjacent a single rod extension wing 332 and in the preferred case of two rod extension wing 332 it slides in between them.

The member plate-interface 215 is preferably convex in the second embodiment 102. The snap-in retract lock 330 includes a snap pin 218 that peripherally engages with a retract cam 250, which is positioned on a peripheral side of at least one but preferably both drive plates 208 as shown in FIG. 8A.

To utilize best in the torque wrench 102 the limited housing bushing radius HBR and housing width HW shown in FIG. 1, a pivoting guide 260 including an arc guide 262 and correspondingly shaped arc mate 264 are employed. The arc mate 264 is positioned on at least one but preferably both drive plates 208. The correspondingly shaped arc guides 262 are recessed into the link housing 103 such that the drive plates 208 are guided pivot able around the torque transfer axis 123A via the link housing 103 while the ratchet wheel 203 is rotating within the link housing 103 peripherally clear of the two drive plates 208. Thus, for a given ratchet teeth width RTW, the housing bushing width HBW is not reduced by any drive plate bushing width DBW and can be brought to a maximum. Correspondingly and for a given maximum housing bushing radius HBR and housing width HW, the attachment flange 118 is provided with a maximum cross section, stiffness and strength. This greatly increases the overall capacity of the torque wrench 102, since the attachment flange 118 is one of the weakest parts in limited clearance torque wrench applications as is well known in the art.

In both embodiments 101, 102 with stacked drive plates 208 in mating contact, the plate-pawl interfaces 233 extend within the ratchet teeth width RTW. This results in maximum surface area and least contact pressures and wear in the plate-pawl interfaces 233, whereby the ratchet wheel 203 features preferably thirteen teeth and three cartridge pawls 232 are employed. Also in both embodiments 101, 102 with stacked drive plates 208 in mating contact, the member-plate interface 215 extends within the ratchet teeth width RTW, which results in maximum surface area and least contact pressures and wear in the member-plate interfaces 233.

To operate the hydraulic torque wrench 101/102 it may be connected via the hose connect swivel 113 to well known hydraulic feed and return hoses via which pressurized hydraulic fluid may be communicated to and from the hydraulic piston 305. Upon build up of fluid pressure, the resulting piston force acting on the ratchet cartridge 201 causes the drive plates 208 to rotate around the torque transfer axis 123A. During such power stroke, the cartridge pawls 232 are engaged with ratchet teeth flanks 205 such that the piston force and rotational movement of the drive plates 208 is transferred onto the ratchet wheel 203 and torque is exerted via the torque transfer feature 123. Once the hydraulic piston 305 has reached its travel end it stalls and fluid flow in the hoses needs to be reversed to return the piston back to its most rearward position. During return travel, the snap mechanism returns the drive plates 208 with its disengaged cartridge pawls 232. The ratchet wheel remains in position until the ratchet cartridge 201 is in its most rearward position and the cartridge pawls 232 engage in the next following set of ratchet teeth flanks 205 and the next power stroke is ready to start.

For the torque wrench 102, once a size of a bolt head or nut to be tightened or loosened is identified, a link 104 with the correspondingly shaped ratchet wheel 203 is selected. While the piston and piston rod 305, 312 are in retracted position, the power head 103 is fully inserted clear of the peripheral coupling hook 142 with its rod support 340 into the cavity in between the link coupling features 152. Next, the power head 103 is rotated with respect to the link 104 around the coupling axis 150A. Thereby, the member-plate interface 215 comes into full contact and the snap pin 218 rides up the release access 213 until it engages with the retract cam 250. The push stone 327 is held in position thereby via the spring loaded push stone slide pin 328 that is engaging in a slide groove 329 of the push stone 327 and that is slide able held in a rod extension wing 332. Once the power head 103 and link 104 are fully coupled, the peripheral housing snap pin 134 snaps into the peripheral coupling hook 142 and the rod support 340 becomes aligned with the rod support guide 344. As the hydraulic piston 305 is pressurized, a push force is exerted via the rod push face 325 onto the push stone 327 and via the member-plate interface 215 onto the drive plates 208. Consequently, the drive plates 208 pivot around the torque transfer axis 123A and move towards the end of the power stroke. The push stone 327 follows thereby the rotating movement of the member-plate interface 215 and slides along the rod push face 325. That way, snug area contact is maintained along the entire force transmission path from the hydraulic piston 305 onto the drive plates 208, which is a prerequisite for a lasting operation of the torque wrench 102. During push force transmission and power stroke, the rod support 340 slides in the rod support guide 344 and supports the piston rod 312 against well known side loads that result from friction in the member-plate interface 215 and the rod push face 325. In case the drive plates 208 were not in fully retracted position while the link 104 and power head 103 were coupled, the spring loaded snap pin 218 may be depressed through well known wedge action while sliding with its front chamfer 223 over the edge of the member-plate interface 215. Latest at the end of a forward stroke, the snap pin 218 becomes engaged with the retract cam 250 such that the drive plates 208 are pulled back during the following return stroke of the hydraulic piston 305 and piston rod 312. The retract cam 250 is shaped such that during return travel, the push stone 327 remains in substantially snug contact with both the rod push face 325 and in the member-plate interface 215. It consequently follows also during return travel the arc path of the member-plate interface 215 and slides up and down the rod push face 325. To disengage the link 104 from the power head 103 at the end of a return stroke, the peripheral housing snap pin 134 is manually depressed. Then, the link 104 is rotated with respect to the power head 103 until the coupling features 151, 152 have cleared. The snap pin 218 moves out of the retract cam 250 at the same time such that the link 104 may be pulled apart from the power head 103.

Accordingly, the scope of the present invention as described in the above and the Figures is set forth by the following claims and their legal equivalent:

What is claimed is:

1. A hydraulic torque wrench comprising:
A. a housing;
B. a hydraulic piston that is slide able along a piston axis guided in said housing and that is transforming a hydraulic pressure into a piston force along a piston axis;
C. a piston force transfer member that is receiving said piston force from said hydraulic piston;
D. at least two drive plates that are receiving said piston force from said piston force transfer member via a member-plate interface;
E. a cartridge pawl that is receiving said piston force from said drive plate via a plate-pawl interface;
F. a ratchet wheel that is rotate able concentric with respect to a torque transfer axis held in said housing and rotate able held on to by said drive plate and that is receiving said piston force from said cartridge pawl via a pawl-tooth interface such that said piston force is transformed into a torque around said torque transfer axis, said ratchet wheel comprising ratchet teeth that are extending along said torque transfer axis with a ratchet teeth width;
wherein said at least two drive plates are stacked and in mating contact with each other along said torque transfer axis and that are extending within said ratchet teeth width.

2. The hydraulic torque wrench of claim 1, further comprising a pivoting guide of at least one of said at least two drive plates and said housing such that said at least two drive plates are guided pivot able via said housing around said torque transfer axis while said ratchet wheel is rotating within said housing peripherally clear of said at least two drive plates.

3. A hydraulic torque wrench comprising:
A. a housing;
B. a hydraulic piston that is slide able along a piston axis guided in said housing and that is transforming a hydraulic pressure into a piston force along a piston axis;
C. a piston force transfer member that is receiving said piston force from said hydraulic piston;
D. at least two drive plates that are receiving said piston force from said piston force transfer member via a member-plate interface;
E. a cartridge pawl that is receiving said piston force from said drive plate via a plate-pawl interface;
F. a ratchet wheel that is rotate able concentric with respect to a torque transfer axis held in said housing and rotate able held on to by said drive plate and that is receiving said piston force from said cartridge pawl via a pawl-tooth interface such that said piston force is transformed into a torque around said torque transfer axis, said ratchet wheel comprising ratchet teeth that are extending along said torque transfer axis with a ratchet teeth width;
wherein said at least two drive plates are stacked and in mating contact with each other along said torque transfer axis and that are extending within said ratchet teeth width such that said member-plate interface is extending within said ratchet teeth width, and
wherein said member-plate interface further comprises a snap-in retract lock.

4. The hydraulic torque wrench of claim 3, wherein said member-plate interface is concave and wherein said snap-in retract lock is a snap pin that is concentric with respect to said concave member-plate interface.

5. The hydraulic torque wrench of claim 4, wherein said snap-in retract lock comprises a release access that is provided by at least one of said at least two drive plates.

6. The hydraulic torque wrench of claim 4, wherein said piston force transfer member is a piston rod and wherein said snap-retract lock comprises a release access that is provided by said piston rod.

7. The hydraulic torque wrench of claim 4, wherein said piston force transfer member is a piston further comprising a spherical rod rear head, and wherein said spherical rod rear head comprises a tightening crown that is radially recessed into said spherical rod rear head.

8. The hydraulic torque wrench of claim 3, wherein said housing comprises:
A. a power head housing that is housing at least said hydraulic piston;
B. a link housing that is housing at least said at least two drives plates, said cartridge pawl and said ratchet wheel; and
C. a pivot coupling that is coupling said power head housing and said link housing rotationally around a coupling axis.

9. The hydraulic torque wrench of claim 8, wherein said coupling axis is coincident with respect to said member-plate interface while said at least two drive plates are in a retract position.

10. The hydraulic torque wrench of claim 8, wherein said power head housing comprises a peripheral housing snap pin and wherein said link housing further comprises a peripheral coupling hook in which said peripheral snap pin snaps in while said link housing is fully coupled with said power head housing.

11. The hydraulic torque wrench of claim 8, wherein said hydraulic piston is rigidly combined with a piston rod, said piston rod comprising on its link end at least one rod extension wing and a rod push face, and wherein said force transfer member is a push stone in slide able snug contact with said rod push face while adjacent said rod extension wing.

12. The hydraulic torque wrench of claim 3, wherein said member-plate interface is convex and wherein said snap-in retract lock is a snap pin that is peripherally engaging with a retract cam that is provided on a peripheral side of at least one of said at least two drive plates.

13. A hydraulic torque wrench comprising:
A. a housing;
B. a hydraulic piston that is slide able along a piston axis guided in said housing and that is transforming a hydraulic pressure into a piston force along a piston axis;
C. a piston force transfer member that is receiving said piston force from said hydraulic piston;
D. at least two drive plates that are receiving said piston force from said piston force transfer member via a member-plate interface;
E. a cartridge pawl that is receiving said piston force from said drive plate via a plate-pawl interface;
F a ratchet wheel that is rotate able concentric with respect to a torque transfer axis held in said housing and rotate able held on to by said drive plate and that is receiving said piston force from said cartridge pawl via a pawl-tooth interface such that said piston force is transformed into a torque around said torque transfer axis, said ratchet wheel comprising ratchet teeth that are extending along said torque transfer axis with a ratchet teeth width;
wherein said at least two drive plates are stacked and in mating contact with each other along said torque transfer axis and that are extending within said ratchet teeth width such that said plate-pawl interface is extending within said ratchet teeth width, and
wherein said pawl-tooth interface comprises a cartridge pawl front face and a ratchet tooth flank that is in a pawl clearance angle with respect to said cartridge pawl end face such that a gap between said cartridge pawl front face and said ratchet tooth flank increases in direction away from said torque transfer axis while said plate-pawl interface is in a substantially load free mating contact.

14. The hydraulic torque wrench of claim 13, wherein at least one of said cartridge pawl front face and said ratchet tooth flank comprise a curvature such that a contact pressure in said pawl-tooth interface propagates in direction away from said torque transfer axis during a load increase and a corresponding elastic deformation in said pawl-tooth interface.

15. The hydraulic torque wrench of claim 13, wherein said ratchet wheel comprises thirteen teeth and wherein three of said cartridge pawls are employed.
